(19) United States
(12) Patent Application Publication
(10) Pub. No.: US 2012/0205307 A1
(43) Pub. Date: Aug. 16, 2012

(54) FLUID TREATMENT APPARATUS AND METHOD

(75) Inventor: Mourad Ben Boudinar, Glasgow (GB)

(73) Assignee: VWS WESTGARTH LIMITED, Hucclecote (UK)

(21) Appl. No.: 13/502,608

(22) PCT Filed: Oct. 26, 2010
(86) PCT No.: PCT/GB2010/001988

§ 371 Date: Apr. 18, 2012

(30) Foreign Application Priority Data
Oct. 27, 2009 (GB) 0918800.4

(51) Int. Cl. C02F 1/44; E21B 43/16; B01D 61/12; E03B 7/07; B01D 61/02; B01D 65/02

(52) U.S. Cl. 210/636; 210/650; 210/652; 137/544; 137/1; 166/305.1

(57) ABSTRACT

A method of treating a fluid comprises producing a permeate fluid (24) from an outlet (22) of a filtration unit (12), delivering the permeate fluid (24) to be injected into a subterranean formation, and recirculating at least a portion of the permeate fluid to be mixed with a source fluid (32) to produce a feed fluid (14) to be treated within the filtration unit (12).

### FIELD OF THE INVENTION

The present invention relates to a fluid treatment method and apparatus, and in particular to a filtration fluid treatment method and apparatus.

### BACKGROUND TO THE INVENTION

Many industries require fluids, such as water, to be treated to establish a particular fluid standard or quality. For example, it may be necessary to remove suspended solids, organic matter and the like from a fluid. Also, it may be desirable to treat a fluid to alter the concentration of one or more ionic species. The treated fluids may be consumed as a final product, for example as potable water, be release into the environment or the like, or may be used in a subsequent process, such as in chemical processing, the oil and gas industry, for example for injection into a reservoir, or the like.

Treatment may include a combination of chemical and mechanical or physical processes. For example, coagulants or flocculants may be added to a fluid to encourage flocculation where heavy particles or flocculus, known as “floc”, are formed. The floc may then be removed by sedimentation and/or by filtration whereby mechanical straining removes a proportion of the particles by trapping them in the filter medium.

Known filtration apparatus for use in treating a fluid to remove particulate material include multimedia filters which consist of two or more layers of different or graded granular material such as gravel, sand and anthracite, for example. The fluid to be treated is passed through the filter and any suspended or dissolved particles or the like will be retained in the interstices between the granules of the different layers.

It is also known in the art to use filtration membranes with selected pore dimensions to filter a fluid. Membranes are known which are capable or removing suspended solids, organic matter and the like, such as microfiltration membranes. Membranes are also known for use in removing or excluding ionic species, such as reverse osmosis membranes.

Over time a filter media or membrane will become clogged with suspended matter, which is normally addressed by a process of backwashing. This typically involves backflowing previously treated fluid through the media or membrane to remove and dispose of the trapped suspended matter. However, in some cases the quality of the raw fluid to be treated is so poor that regular backwashing is necessary, which is undesirable. To address this it is known in the art to provide pre-filtration arrangements, in which an initial filtration process is performed to remove a large proportion of the suspended matter from the fluid which is passed for further treatment. However, the addition of extra plant equipment to establish pre-filtration in many cases is not desirable, for example in applications on offshore platforms or vessels where space is at a premium.

### SUMMARY OF THE INVENTION

According to a first aspect of the present invention there is provided a method of treating a fluid, comprising:

producing a permeate fluid from an outlet of a filtration unit; and

recirculating at least a portion of the permeate fluid to be mixed with a source fluid to produce a feed fluid to be treated within the filtration unit.

The recirculated permeate fluid, which has already been treated, may be used to dilute the source fluid to be treated to achieve a feed fluid with a desired fluid condition or property prior to being treated within the filtration unit. For example, mixing of recirculated permeate fluid with source fluid may provide a feed fluid with a desired fluid condition or property such as turbidity, ionic concentration, suspended matter content including, for example, suspended solids, organic matter, or the like.

The desired fluid condition or property may be selected in accordance with the filtration unit. For example, the desired fluid condition or property may be selected to minimise plugging or contamination of the filtration unit, for example by suspended solids and the like contained within the feed fluid. This may reduce or minimise the cleaning frequency requirement of the filtration unit, for example by backwashing. Furthermore, dilution of the source fluid with recirculated permeate fluid may permit use of the filtration unit with minimal, reduced or no pre-filtration of the feed fluid. However, in some embodiments the present invention may comprise pre-filtering the source fluid and/or feed fluid prior to being treated within the filtration unit.

The method may comprise mixing the source fluid and permeate fluid within a mixing arrangement. The method may comprise mixing the source fluid and permeate fluid within a pump arrangement. The method may comprise mixing the source fluid and permeate fluid within an eductor arrangement.

The method may comprise mixing the source fluid and permeate fluid within an inlet of the filtration unit.

The method may comprise mixing the source fluid and permeate within the filtration unit. In one embodiment the filtration unit may comprise a first inlet configured to receive the source fluid, and a second inlet configured to receive the recirculated permeate fluid.

The method may comprise recirculating permeate fluid by pumping said permeate fluid from the outlet of the filtration unit.

The method may comprise controlling recirculation of the permeate fluid. Control of recirculation of the permeate fluid may be achieved by use of a flow control device, such as a valve, pump, nozzle or the like.

The method may comprise selectively recirculating permeate fluid. Selectively recirculating permeate fluid may comprise preventing recirculation. Selectively recirculating permeate fluid may comprise modulating the recirculation flow rate.

The method may comprise determining a property of the source fluid and controlling recirculation of the permeate fluid in accordance with said source fluid determined property. The determined property may comprise turbidity, a measure of total suspended solids, ionic concentration or the like. In this arrangement recirculation of the permeate fluid may be controlled and modified to provide a desired volume of permeate fluid to modify one or more properties of the source fluid. In this way a suitable feed fluid may be produced to be treated within the filtration unit.

The method may comprise determining a property of the feed fluid and controlling recirculation of the permeate fluid in accordance with said feed fluid determined property. The method may comprise monitoring a property of the feed fluid and controlling recirculation of the permeate fluid to achieve a desired value, magnitude or the like of the monitored property, such as turbidity.

The method may comprise determining a property of the permeate fluid and controlling recirculation of said permeate fluid in accordance with said determined property.

The method may comprise determining one or more properties of at least two of the source fluid, feed fluid a permeate fluid, and controlling recirculation of the permeate fluid in accordance with said one or more monitored properties.

The method may comprise monitoring a condition or property of at least one of the source fluid, feed fluid and permeate fluid and controlling recirculation of the permeate fluid accordingly. Such monitoring may permit a degree of continuous control of recirculation of the permeate fluid to provide a desired feed fluid condition prior to treatment within the filtration unit.

The method may be configured to establish a feed fluid with a turbidity greater than 3 NTU. The method may be configured to produce a permeate fluid with a turbidity less than 0.1 NTU. The method may be configured to recirculate up to around 50%, and perhaps up to around 25% of a flux capacity of the filtration unit.

The method may comprise directly recirculating permeate fluid from the outlet of the filtration unit. The method may comprise storing permeate fluid and recirculating said stored permeate fluid.

The filtration unit may be configured to remove suspended matter from the feed fluid. The filtration unit may be configured to remove dissolved matter from the feed fluid. The filtration unit may be configured to remove one or more ionic species from the feed fluid, such as sulphate ions.

The filtration unit may comprise a filtration media, such as gravel, sand, anthracite, nut shells or the like.

The filtration unit may comprise at least one membrane. The filtration unit may comprise at least one micro-filtration membrane. The filtration unit may comprise at least one ultra-filtration membrane. The filtration unit may comprise at least one nano-filtration membrane. The filtration unit may comprise at least one reverse osmosis membrane.

The filtration unit may comprise a polymeric membrane. The filtration unit may comprise a ceramic membrane.

The filtration unit may comprise a combination of membrane types, such as those membrane types defined above.

The method may comprise treating at least one of the source fluid and feed fluid prior to being delivered to the filtration unit. This pre-treatment may assist to establish a desired feed fluid condition or property suitable or preferred for the filtration unit. The method may comprise pre-treating at least one of the source fluid and feed fluid by addition of a chemical, such as a flocculant, pH adjustor or the like. The method may comprise pre-treating at least one of the source fluid and feed fluid by pre-filtration. The method may comprise delivering at least one of the source fluid and feed fluid to a pre-filtration unit, which may comprise a filtration media, membrane or the like. The pre-filtration unit may comprise at least one or any combination of membrane types, such as those identified above.

The method may comprise backwashing a pre-filtration unit. Backwashing may be performed using a backwash fluid. The backwash fluid may be provided from an external source.

In one embodiment the filtration unit may be configured to produce a concentrate fluid, wherein said concentrate fluid is used to backwash a pre-filtration unit. The concentrate fluid may be used directly from the filtration unit for backwashing. The concentrate fluid may be collected and stored for subsequent use in backwashing of a pre-filtration unit.

The pre-filtration unit may be backwashed using a permeate fluid produced from said pre-filtration unit. The pre-filtration unit permeate fluid may be used directly from the pre-filtration unit for backwashing. The pre-filtration unit permeate fluid may be collected and stored for subsequent use in backwashing of the pre-filtration unit.

The method may comprise delivering a portion of permeate fluid from the filtration unit as a product. The product permeate fluid may be consumed, for example as potable water. The product permeate fluid may be injected into a subterranean formation. The product permeate fluid may be released into the environment, for example into the sea.

The source fluid may comprise seawater. The source fluid may comprise water produced from a subterranean formation, such as an aquifer, a hydrocarbon bearing formation or the like.

According to a second aspect of the present invention there is provided a fluid treatment apparatus comprising:

a filtration unit configured to treat a feed fluid and produce a permeate fluid therefrom; and

a recirculating arrangement configured to recirculate at least a portion of permeate fluid to be mixed with a source fluid to produce a feed fluid to be treated within the filtration unit.

The recirculating arrangement may permit a source fluid to be diluted with permeate fluid, which has already been treated, to achieve a feed fluid with a desired fluid condition or property prior to being treated within the filtration unit. For example, mixing of recirculated permeate fluid with source fluid may provide a feed fluid with a desired fluid condition or property such as turbidity, ionic concentration, suspended matter content including, for example, suspended solids, organic matter, or the like.

The apparatus according to the second aspect may be used to perform the method according to the first aspect. As such, features defined above in relation to the first aspect may also apply to the second aspect.

The apparatus may comprise a mixing arrangement configured to permit mixing of the source fluid and permeate. The apparatus may comprise a pump arrangement configured to permit mixing of the source fluid and permeate fluid. The apparatus may comprise an eductor arrangement configured to permit mixing of the source fluid and permeate fluid.

The filtration unit may comprise an inlet configured to permit mixing of the source fluid and permeate fluid therein.

The filtration unit may be configured to permit mixing of the source fluid and permeate within the filtration unit. In one embodiment the filtration unit may comprise a first inlet configured to receive the source fluid, and a second inlet configured to receive the recirculated permeate fluid.

The recirculating arrangement may comprise a conduit configured to divert at least a portion of the permeate fluid from the outlet of the filtration unit. The recirculating arrangement may comprise a recirculating pump. The recirculating arrangement may comprise a flow control device, such as a valve.

The recirculating arrangement may be configured to selectively recirculate permeate fluid.

The apparatus may comprise a controller configured to control recirculation of the permeate fluid.

The apparatus may comprise a sensor arrangement configured to permit at least one fluid property to be determined, such as a fluid property of at least one of the permeate fluid, source fluid and feed fluid.

The apparatus may be configured to determining a property of the source fluid and control, for example by use of a controller, recirculation of the permeate fluid in accordance with said source fluid determined property.

The apparatus may be configured to determine a property of the feed fluid and control recirculation of the permeate fluid in accordance with said feed fluid determined property.

The apparatus may be configured to determine a property of the permeate fluid and control recirculation of said permeate fluid in accordance with said determined property.

The apparatus may be configured to determine one or more properties of at least two of the source fluid, feed fluid a permeate fluid, and control recirculation of the permeate fluid in accordance with said one or more monitored properties.

The apparatus may be configured to monitor a condition or property of at least one of the source fluid, feed fluid and permeate fluid and control recirculation of the permeate fluid accordingly.

The apparatus may comprise a storage arrangement configured for storing permeate fluid for recirculation.

The filtration unit may be configured to remove suspended matter from the feed fluid. The filtration unit may be configured to remove dissolved matter from the feed fluid. The filtration unit may be configured to remove one or more ionic species from the feed fluid, such as sulphate ions.

The filtration unit may comprise a filtration media, such as gravel, sand, anthracite, nut shells or the like.

The filtration unit may comprise at least one membrane. The filtration unit may comprise at least one micro-filtration membrane. The filtration unit may comprise at least one ultra-filtration membrane. The filtration unit may comprise at least one nano-filtration membrane. The filtration unit may comprise at least one reverse osmosis membrane.

The filtration unit may comprise a polymeric membrane. The filtration unit may comprise a ceramic membrane.

The filtration unit may comprise a combination of membrane types, such as those membrane types defined above.

The apparatus may comprise a pre-treatment arrangement configured to treat at least one of the source fluid and feed fluid prior to being delivered to the filtration unit. The apparatus may comprise a pre-filtration unit configured to pre-treating at least one of the source fluid and feed fluid by pre-filtration. The pre-filtration unit may comprise at least one or any combination of membrane types, such as those identified above.

The pre-filtration unit may be configured to be backwashed. The pre-filtration unit may be configured to be backwashed with at least one of a permeate fluid from the filtration unit, a concentrate fluid from the filtration unit and a permeate fluid from the pre-filtration unit.

According to a third aspect of the present invention there is provided a method of controlling a fluid treatment process, comprising:

determining a fluid property or at least one of a permeate fluid from a filtration unit, a source fluid and a feed fluid to be treated within the filtration unit; and

mixing a proportion of the permeate fluid with the source fluid to produce a feed fluid in accordance with said determined fluid property.

The method according to the third aspect may incorporate features associated with the first or second aspects.

According to a fourth aspect of the present invention there is provided a method of treating injection water prior to injection into a reservoir, comprising:

producing a treated injection fluid from an outlet of a filtration unit; and

recirculating at least a portion of the treated injection fluid to be mixed with a source fluid to produce a feed fluid to be treated within the filtration unit.

The source fluid may comprise seawater. The source fluid may comprise water produced from a subterranean formation.

### BRIEF DESCRIPTION OF THE DRAWINGS

These and other aspects of the present invention will now be described, by way of example only, with reference to the accompanying drawings, in which:

FIG. 1 is diagrammatic representation of a fluid treatment apparatus in accordance with an embodiment of the present invention;

FIG. 2 is a diagrammatic representation of a fluid treatment apparatus in accordance with an alternative embodiment of the present invention; and

FIG. 3 is a diagrammatic representation of a fluid treatment apparatus in accordance with a further alternative embodiment of the present invention.

### DETAILED DESCRIPTION OF THE DRAWINGS

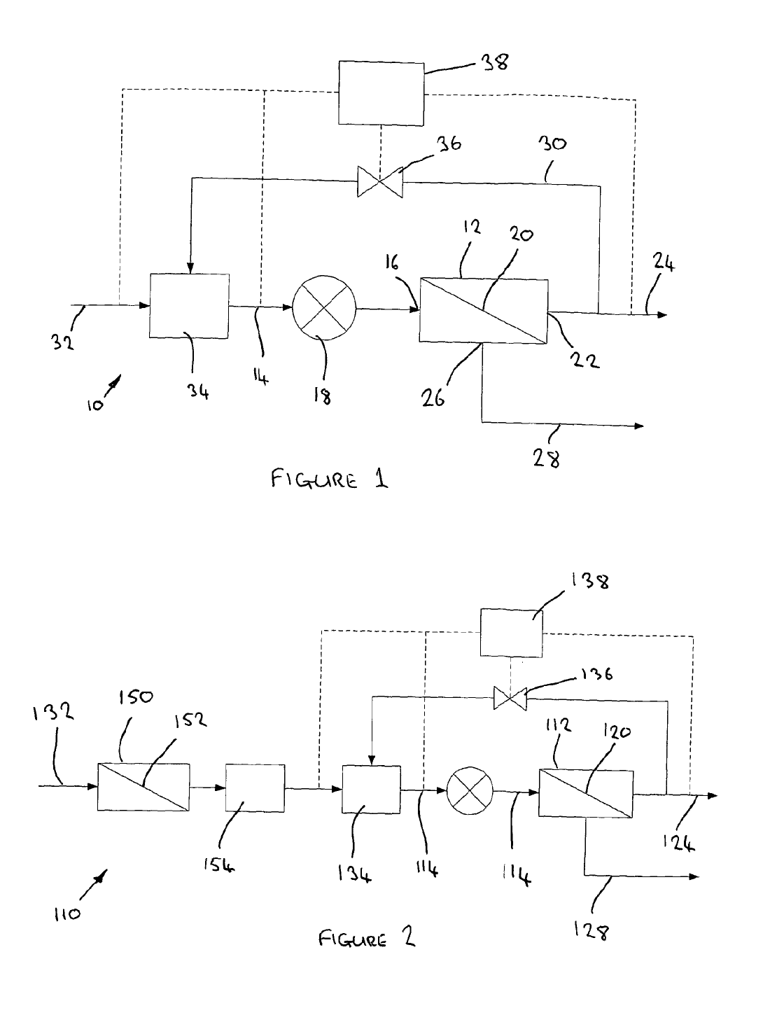

A fluid treatment system, generally identified by reference numeral 10, in accordance with an embodiment of the present invention is shown diagrammatically in FIG. 1. The fluid treatment system 10 in the embodiment shown is configured to treat seawater prior to injection into a subterranean formation or reservoir. Specifically, the system 10 is configured to remove suspended or dissolved matter and to alter the concentration of an ionic species within the seawater to make the seawater chemistry compatible with that within the reservoir. Although this specific embodiment for treating seawater for injection is described, the present invention has multiple alternative uses, with multiple types of fluids.

The system 10 comprises a filtration unit 12 which is configured to receive a stream of feed fluid 14 to be treated via a fluid inlet 16, wherein the feed fluid 14 is driven by a pump 18. The filtration unit 12 comprises a filtration membrane 20, specifically a nano-filtration membrane, which is configured for operation in a cross-flow mode. In use, the feed fluid 14 is driven through the membrane 20 to be treated by removal or exclusion of particulate matter and specific ionic species, particularly sulphate ions. The filtration unit 12 comprises a first fluid outlet 22 configured to accommodate a flow of permeate fluid 24 from the unit 12, and a second fluid outlet 26 configured to accommodate a flow of concentrate fluid 28 from the unit 12. The permeate fluid 24 will have a lower concentration of particulate matter and ionic species than the concentrate fluid 28. In the embodiment shown the permeate fluid 24 is injected into a reservoir (not shown).

The apparatus 10 is configured such that a portion of the permeate fluid 24 may be selectively recirculated, via conduit 30, to be mixed with a source fluid 32, specifically seawater, within a mixing arrangement 34. Accordingly, the feed fluid 14 is produced by appropriate mixing or blending of the treated permeate fluid 24 and untreated source fluid 32. Thus, the recirculated permeate fluid 24 may be used to dilute the source fluid 32 to achieve a feed fluid 14 with a desired fluid condition or property prior to being treated within the filtration unit 12. For example, mixing of recirculated permeate fluid 24 with source fluid 32 may provide a feed fluid 14 with a desired fluid condition or property such as turbidity, ionic concentration, suspended matter content including, or the like. The desired fluid condition or property may be selected to minimise plugging or contamination of the membrane 20 within the filtration unit 12, for example by suspended solids and the like. This may reduce or minimise the cleaning frequency requirement of the filtration unit 12, for example by backwashing. In this regard it is highly desirable to reduce the frequency of backwashing cycles, as backwashing can temporarily reduce the flux output of the system 10, requires a significant wastage of treated water, and may require dedicated space for storage of backwash water. Furthermore, dilution of the source fluid 32 with recirculated permeate fluid 24 may permit use of the filtration unit with minimal, reduced or no pre-filtration of the feed fluid 14. However, in some embodiments, as discussed below, the present invention may comprise pre-filtering the source fluid 32 prior to being treated within the filtration unit 12.

The system 10 further comprises a control valve 36 configured for use in controlling recirculation of the permeate fluid 24 via conduit 30. In this respect the valve 36 may be controlled by a controller 38. The controller may be manually operated, for example by a user. However, in the present embodiment the controller is configured to permit automatic control of the valve 36 and thus recirculation of the permeate fluid 24. Specifically, the controller 38 is configured to monitor the condition, for example turbidity, of one or all of the source fluid 32, feed fluid 14 and permeate fluid 24, and then controlling the valve 36 to selectively vary recirculation of the permeate fluid to provide a desired feed fluid condition prior to treatment within the filtration unit.

Although not shown within the system 10 of FIG. 1, a pump may be provided for recirculation of the permeate fluid 24.

The embodiment shown in FIG. 1 may be configured to establish a feed fluid 14 with a turbidity greater than 3 NTU, and produce a permeate fluid with a turbidity less than 0.1 NTU. Furthermore, the system 10 may be configured to recirculate up to around 50%, and perhaps up to around 25% of the flux capacity of the filtration unit 12.

Reference is now made to FIG. 2 of the drawings in which there is shown a fluid treatment system, generally identified by reference numeral 110, in accordance with an alternative embodiment of the present invention. The system 110 is similar to that of FIG. 1, and as such like features share like reference numerals, incremented by 100. Thus, system 110 comprises a filtration unit 112 with membrane 120 which treats a feed fluid 114 to produce a permeate fluid 124 and a concentrate fluid 128. The permeate fluid may be recirculated via a valve 136 and controller 138 to be mixed with a source fluid 132 within a mixer 134 to produce feed fluid 114 with a desired quality. However, the system 110 of FIG. 1 additionally comprises a pre-filtration unit 150 which includes a filtration membrane 152, specifically an ultra-filtration or micro-filtration membrane, wherein the pre-filtration unit 150 is configured to pre-treat the source fluid 132 to remove larger suspended solids prior to being delivered to the filtration unit 112. This arrangement may therefore serve to protect the membrane 120 within the filtration unit 112 from clogging of plugging or the like. The system 110 also comprises an optional storage tank 154 for storing source fluid 132 which has been pre-treated.

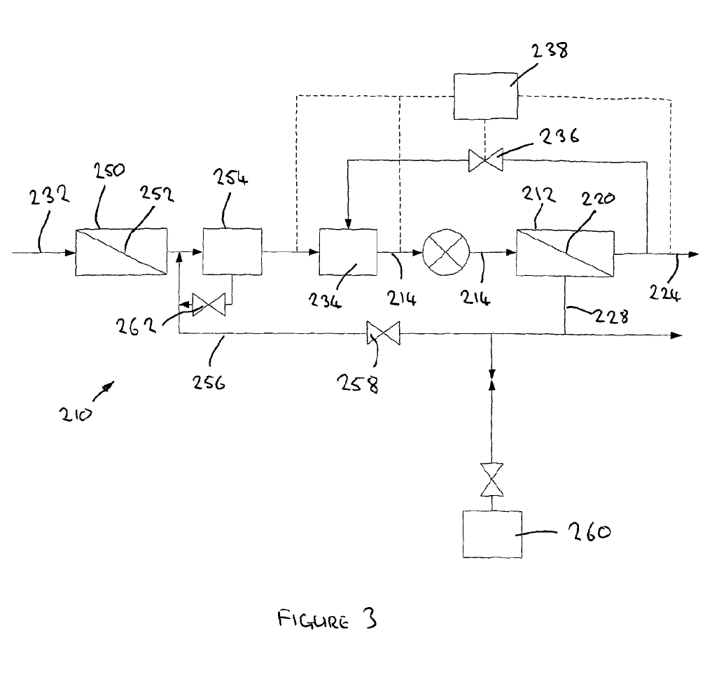

A further alternative embodiment of a fluid treatment system, generally identified by reference numeral 210, is shown in FIG. 3, wherein system 210 is similar to that shown in FIG. 2 and as such shares like reference numerals, incremented by 100. Accordingly, system 210 comprises a filtration unit 212 with membrane 220 which treats a feed fluid 214 to produce a permeate fluid 224 and a concentrate fluid 228. The permeate fluid 224 may be recirculated via a valve 236 and controller 238 to be mixed with a source fluid 232 to produce feed fluid 214 with a desired quality. System 210 also comprises a pre-filtration unit 250 and filtration membrane 252 for pre-treating the source fluid 232 to remove larger suspended solids prior to being delivered to the filtration unit 212.

The system 210 further comprises a conduit 256 configured to permit selective communication of the concentrate fluid 228 from the filtration unit 212 to be delivered to the pre-filtration unit 250 for use in backwashing of the membrane 252. A valve 258 is provided to selectively control the delivery of the concentrate fluid 228.

A storage tank 260 may optionally be provided to store concentrate fluid 228 in preparation for backwashing of the membrane 252 within the pre-filtration unit 250.

Furthermore, the system 210 may optionally comprise a storage tank 254 configured to store pre-treated source fluid 232. Further, the system 210 may be configured to permit pre-treated source fluid 232 stored within the storage tank 254 to be recirculated, by use of valve 262, to backwash the pre-filtration membrane 252.

It should be understood that the embodiments described herein are merely exemplary and that various modifications may be made thereto without departing from the scope of the invention. For example, although single filtration units and single membranes are disclosed, a plurality of each may be provided, which may be arranged in any suitable manner, for example in parallel, series or the like. Additionally, the filtration unit may comprise any type of filtration media, such as other membrane types, granular material or the like.

1.-28. (canceled)

29. A method of treating a fluid, comprising:
producing a permeate fluid from an outlet of a filtration unit;
delivering the permeate fluid to be injected into a subterranean formation; and
controllably recirculating at least a portion of the permeate fluid to be mixed with a source fluid to produce a feed fluid to be treated within the filtration unit.

30. The method of claim 29, comprising mixing the source fluid and permeate fluid within a mixing arrangement.

31. The method of claim 29, comprising mixing the source fluid and permeate fluid within an inlet of the filtration unit.

32. The method of claim 29, comprising mixing the source fluid and permeate within the filtration unit.

33. The method according to claim 29, comprising selectively recirculating permeate fluid.

34. The method according to claim 33, wherein selectively recirculating permeate fluid comprises preventing recirculation.

35. The method according to claim 33, wherein selectively recirculating permeate fluid comprises modulating the recirculation flow rate.

36. The method according to claim 29, comprising determining a property of the source fluid and controlling recirculation of the permeate fluid in accordance with said source fluid determined property.

37. The method according to claim 29, comprising determining a property of the feed fluid and controlling recirculation of the permeate fluid in accordance with said feed fluid determined property.

38. The method according to claim 29, comprising determining a property of the permeate fluid and controlling recirculation of said permeate fluid in accordance with said determined property.

39. The method according to claim 29, comprising determining one or more properties of at least two of the source fluid, feed fluid a permeate fluid, and controlling recirculation of the permeate fluid in accordance with said one or more monitored properties.

40. The method according to claim 29, comprising monitoring a condition or property of at least one of the source fluid, feed fluid and permeate fluid and controlling recirculation of the permeate fluid accordingly.

41. The method according to claim 29, comprising directly recirculating permeate fluid from the outlet of the filtration unit.

42. The method according to claim 29, comprising storing permeate fluid and recirculating said stored permeate fluid.

43. The method according to claim 29, wherein the filtration unit is configured to remove at least one of suspended matter, dissolved matter and one or more ionic species from the feed fluid.

44. The method according to claim 29, wherein the filtration unit comprises a filtration media.

45. The method according to claim 29, wherein the filtration unit comprises at least one membrane.

46. The method according to claim 29, wherein the filtration unit comprises at least one of a micro-filtration membrane, ultra-filtration membrane, nano-filtration membrane and a reverse osmosis membrane.

47. The method according to claim 29, comprising treating at least one of the source fluid and feed fluid prior to being delivered to the filtration unit.

48. The method according to claim 47, comprising pre-treating at least one of the source fluid and feed fluid by addition of a chemical.

49. The method according to claim 47, comprising pre-treating at least one of the source fluid and feed fluid by pre-filtration.

50. The method according to claim 47, comprising delivering at least one of the source fluid and feed fluid to a pre-filtration unit.

51. The method according to claim 50, comprising backwashing the pre-filtration unit.

52. The method according to claim 51, wherein the filtration unit is configured to produce a concentrate fluid, wherein said concentrate fluid is used to backwash a pre-filtration unit.

53. A fluid injection apparatus comprising:
a filtration unit configured to treat a feed fluid and produce a permeate fluid therefrom and deliver said permeate fluid to be injected into a subterranean formation; and
a recirculating arrangement configured to controllably recirculate at least a portion of permeate fluid to be mixed with a source fluid to produce a feed fluid to be treated within the filtration unit.

54. A method of injecting water into a subterranean formation, comprising:
producing a treated water fluid from an outlet of a filtration unit;
injecting said treated water into a subterranean formation; and
recirculating at least a portion of the treated water to be mixed with a source fluid to produce a feed fluid to be treated within the filtration unit.

55. A method of controlling a fluid treatment process, comprising:
determining a fluid property of at least one of a permeate fluid from a filtration unit, a source fluid and a feed fluid to be treated within the filtration unit; and
mixing a proportion of the permeate fluid with the source fluid to produce a feed fluid in accordance with said determined fluid property.

56. A method of treating a fluid, comprising:
producing a permeate fluid from an outlet of a filtration unit;
delivering the permeate fluid to be injected into a subterranean formation; and
controllably recirculating at least a portion of the permeate fluid to be mixed with a source fluid to produce a feed fluid to be treated within the filtration unit.

57. A fluid injection apparatus comprising:
a filtration unit configured to treat a feed fluid and produce a permeate fluid therefrom and deliver said permeate fluid to be injected into a subterranean formation; and
a recirculating arrangement configured to recirculate at least a portion of permeate fluid to be mixed with a source fluid to produce a feed fluid to be treated within the filtration unit.

58. The method according to claim 29, comprising controllably recirculating at least a portion of the permeate fluid to dilute the source fluid to produce a feed fluid with desired fluid properties.

59. The method according to claim 58, wherein the source fluid is controllably diluted by the permeate to provide a feed fluid with a desired fluid property to minimise fouling of the filtration unit.
